(19) United States
(12) Patent Application Publication
(10) Pub. No.: US 2013/0302620 A1
(43) Pub. Date: Nov. 14, 2013

(54) BASECOAT WITH IMPROVED ADHESION TO BIOPLASTIC

(71) Applicants: David R. Fenn, Allison Park, PA (US); Jackie L. Kulfan, Valencia, PA (US); Anthony M. Chasser, Allison Park, PA (US)

(72) Inventors: David R. Fenn, Allison Park, PA (US); Jackie L. Kulfan, Valencia, PA (US); Anthony M. Chasser, Allison Park, PA (US)

(73) Assignee: PPG Industries Ohio, Inc., Cleveland, OH (US)

(21) Appl. No.: 13/467,078

(22) Filed: May 9, 2012

(51) Int. Cl. C09D 163/02; B32B 27/08; B32B 27/38

(52) U.S. Cl. 428/412; 523/400; 428/413

(57) ABSTRACT

A coating composition comprising the reaction product of an epoxy-functional backbone resin having free hydroxyl groups and a lactide is disclosed.

### FIELD OF THE INVENTION

The present invention is directed to coating compositions that include a reaction product comprising an epoxy-functional backbone resin having free hydroxyl groups and a lactide.

### BACKGROUND OF THE INVENTION

The price of materials used to manufacture various products including consumer products, such as electronics, continues to rise due to the fluctuations in the price of oil. As such, raw materials derived from renewable resources or other alternative resources may be desirable, such as bioplastics. In addition, products based on renewable resources may be more sustainable and are sometimes preferred to non-sustainable products by consumers. By “bioplastics” it is meant materials such as biopolyesters, for example polyhydroxyalkanoates such as poly-3-hydroxybutyrate, polyhydroxyvalerate, polyhydroxyhexanoate or poly(lactic acid) or biobased polycarbonates. In general, such bioplastics have some carbonaceous material that was obtained from living or recently living organisms, such as plants (including trees) or animals and not from a petroleum based source.

In order to coat a substrate produced from such bioplastic material, the coating compositions should have sufficient adhesion to the bioplastic substrate as well as adhesion to any basecoats thereon.

### SUMMARY OF THE INVENTION

The present invention is directed to a coating composition comprising a reaction product comprising (a) an epoxy-functional backbone resin having free hydroxyl groups and (b) a lactide. Substrates coated therewith are also disclosed.

### DESCRIPTION OF THE INVENTION

The present invention is directed to a coating composition comprising a reaction product comprising (a) an epoxy-functional backbone resin having free hydroxyl groups and (b) a lactide. The reaction product is sometimes referred to herein as the “lactide reaction product” or “reaction product” or similar terms. A feature of certain embodiments of the lactide reaction product is that at least one pendent lactide unit extends from the epoxy-functional backbone resin.

It will be appreciated by those skilled in the art that free hydroxyl groups on the epoxy-functional backbone resin will react with the lactide to form lactide units. By “lactide unit” it is meant one or more lactide segments. A lactide segment is a residue of one lactide molecule. A lactide unit can therefore be one lactide segment or one or more lactide segments (sometimes referred to as a polylactide). For example, a polylactide having five lactide segments is produced from five lactide molecules. In certain embodiments, the reaction product of the present invention includes polylactides comprising 2-5 lactide segments.

The free hydroxyl groups present on the epoxy-functional backbone resin are provided in an amount which, upon reaction with the lactide, provides sufficient pendent lactide units for adhesion to a basecoat or underlying substrate, such as a bioplastic. Any suitable lactide can be used in reaction with the hydroxyl groups on the epoxy-functional backbone resin, such as L-lactide, meso-lactide, or D-lactide. Mixtures of any of the isomers can also be used. Lactide is the cyclic diester of lactic acid (2-hydroxypropionic acid). Similar lactides are also commercially available. Lactide is a common synonym for 3,6-dimethyl-1,4-dioxane-2,5-dione.

The epoxy-functional backbone resin having free hydroxyl groups (i.e., hydroxyl groups capable of reaction with the lactide) used in the present invention includes sufficient free hydroxyl group content for reaction with the lactide to render the reaction product suitable for use as an adhesion promoter. In certain embodiments, the epoxy-functional backbone resin includes aromatic groups, such as a resin-based diglycidyl ether of bisphenol A and residues thereof, such as the epoxy resins sold under the name Epikote™ by Resolution Performance Products. The particular epoxy resin employed in the present invention may be selected based on the hydroxyl group content thereof. For example, a suitable number average molecular weight (Mₙ) of the epoxy-functional backbone resin is about 1,000 to 10,000 as determined by gel permeation chromatography in tetrahydrofuran relative to linear polystyrene standards. The hydroxyl value of the epoxy-functional backbone resin may be 1 to 6 mol/kg resin or 2 to 5 mol/kg resin or 3 to 4 mol/kg resin.

The lactide reaction product of the present invention can be formed by reacting the lactide and the epoxy-functional resin under any suitable conditions. For example, the epoxy-functional backbone resin with free hydroxyl groups may be mixed with the lactide and heated to a temperature of 100° C.-150° C. for a period of 2-10 hours. The reaction can be carried out in the presence of a catalyst, for example complexes of tin, aluminum, zinc, and lanthanides. Tin compounds, such as stanous octoate, are particularly suitable. The reaction can be carried out in bulk or in the presence of solvents. As note above, the lactide reaction product includes pendent lactide units. The molar ratio of lactide segments of the reaction product to free hydroxyl groups present on the epoxy-functional backbone resin before reaction with the lactide may be from 1:50 to 1:0.2, such as 1:10 to 1:1 or 1:5 to 1:2 or 1:1 to 5:1 or 1:1 to 3:1.

The coating composition of the present invention can comprise 1-85 percent by weight (wt. %), such as 3-60 wt. % or 5-40 wt. % of the lactide reaction product described herein, with the weight percent based on total solids weight of the coating composition.

It will also be appreciated that when one or more of the reaction products of the present invention are used in a coating according to the present invention, one or more additional film-forming or resinous binders may also be used in the coating composition, such as thermoplastic and/or thermosetting compositions that are known in the art. The coating compositions may be water-based, solvent-based, or, alternatively, may be in solid particulate form, i.e., a powder coating. In certain embodiments, the coating compositions may be very high solids, such as 80% solids or greater, 90%, 95%, 98%, 99% or greater.

Thermosetting or curable coating compositions typically comprise film-forming polymers or resins having functional groups that are reactive with either themselves or a crosslinking agent. The additional film-forming resin can be selected from, for example, acrylic polymers, polyester polymers, polyurethane polymers, polyamide polymers, polyether polymers, polysiloxane polymers, copolymers thereof, and mixtures thereof. Generally these polymers can be any polymers of these types made by any method known to those skilled in the art. Such polymers may be solvent borne or water dispersible, emulsifiable, or of limited water solubility. The functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups), mercaptan groups, and combinations thereof. Appropriate mixtures of film-forming resins may also be used in the preparation of the coating compositions.

If additional thermosetting coating compositions are used, they may be self-crosslinking, that is, they may have functional groups that are reactive with themselves, or a crosslinking agent may be added that is reactive with the lactide reaction product. The crosslinking agent can comprise melamines, polyisocyanates, blocked polyisocyanates, aminoplasts, polyepoxides, beta hydroxyalkylamides, polyacids, anhydrides, organometallic acid-functional materials, polyamines, polyamides, and mixtures of any of these, all of which are known in the art.

In certain embodiments, the coating comprises a film-forming resin, monomer oligomer or reactive diluents that comprises a radiation curable moiety and/or is radiation curable. Examples include polyester(meth)acrylates, epoxy(meth)acrylates, urethane(meth)acrylates and highly functional (meth)acrylates such as tetra functional (meth)acrylates, such as, for example, di-trimethylolpropane tetraacrylate, ethoxylated 4-pentaerythritol tetraacrylate, pentaerythritol ethoxylate tetraacrylate, pentaerythritol propoxylate tetraacrylate, including mixtures thereof; penta functional (meth)acrylates, such as, for example, dipentaerythritol pentaacrylate, dipentaerythritol ethoxylate pentaacrylate, and dipentaerythritol propoxylate pentaacrylate, including mixtures thereof; and hexa functional (meth)acrylates, such as the commercially available products EBECRYL 1290 and EBECRYL 8301 hexafunctional aliphatic urethane acrylate (both available from UCB Chemicals); EBECRYL 220 hexafunctional aromatic urethane acrylate (available from UCB Chemicals); EBECRYL 830, EBECRYL 835, EBECRYL 870 and EBECRYL 2870 hexafunctional polyester acrylates (all available from UCB Chemicals); EBECRYL 450 fatty acid modified polyester hexaacrylate (available from UCB Chemicals); DPHA dipentaerythritol hexaacrylate (functionality 6; available from UCB Chemicals); and mixtures of any of the foregoing.

In certain embodiments, the coatings of the present invention can be “dual cure”, i.e. the coatings may be cured by more than one mechanism. For example, the lactide reaction product may react with one type of crosslinker while the additional film-forming resin reacts with a different crosslinker. In another example, the lactide reaction product may react with one type of crosslinker while the additional film-forming resin is self-crosslinking or radiation curable, such as an acrylic resin. In yet another example, the crosslinker may comprise two different functional groups, one that reacts with the lactide reaction product and another that reacts with any additional film-forming resin in the coating. In certain embodiments, the lactide reaction product can comprise a radiation curable moiety and a hydroxyl group, for example, which can be further reacted with an appropriate crosslinker, such as aminoplast crosslinkers, blocked or unblocked isocyanates. Aminoplast crosslinkers can be melamine based, urea based or benzoguanamine based.

The coating compositions of the present invention may also include a solvent and/or reactive diluent. Suitable solvents include water, organic solvent(s), and/or mixtures thereof. Suitable organic solvents include glycols, glycol ether alcohols, alcohols, ketones, and aromatics, such as xylene and toluene, acetates, mineral spirits, naphthas, and/or mixtures thereof. “Acetates” include the glycol ether acetates. The solvents can be biomass derived. Examples of biomass derived solvents include ethyl acetate, butyl acetate, acetone, esters of lactic acid and esters of soybean oil fatty acid. In certain embodiments, the solvent is a non-aqueous solvent. “Non-aqueous solvent” and like terms mean that less than 50% of the solvent is water. For example, less than 10%, or even less than 5% of the solvent can be water. It will be understood that mixtures of solvents, including or excluding water in an amount of less than 50%, can constitute a “non-aqueous solvent”. In other embodiments, the coating is aqueous or water-based. This means that 50% or more of the solvent is water. These embodiments have less than 50%, such as less than 20%, less than 10%, less than 5%, or less than 2% solvent.

If desired, the coating compositions can comprise other optional materials well known in the art of formulating coatings, such as colorants, plasticizers, antioxidants, abrasion-resistant particles, hindered amine light stabilizers, UV light absorbers and stabilizers, surfactants, flow control agents, antifoaming agents, wetting agents, thixotropic agents, fillers, waxes, lubricants, fortifiers, stabilizers, organic cosolvents, reactive diluents, catalysts, grind vehicles, and other customary auxiliaries.

As used herein, the term “colorant” means any substance that imparts color and/or other opacity and/or other visual effect to the composition. The colorant can be added to the coating in any suitable form, such as discrete particles, dispersions, solutions, and/or flakes. A single colorant or a mixture of two or more colorants can be used in the coatings of the present invention. A “filler” on the other hand, does not necessarily impart any color and/or opacity and/or other visual effect to the composition.

Example colorants include pigments, dyes, and tints, such as those used in the paint industry and/or listed in the Dry Color Manufacturers Association (DCMA), as well as special-effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent and/or aqueous based, such as acid dyes, azoic dyes, basic dyes, direct dyes, disperse dyes, reactive dyes, solvent dyes, sulfur dyes, mordant dyes, for example, bismuth vanadate, anthraquinone, perylene aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers, such as AQUA-CHEM 896 commercially available from Degussa, Inc., CHARISMA COLORANTS and MAXITONER INDUSTRIAL COLORANTS commercially available from Accurate Dispersions division of Eastman Chemicals, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants, such as pigments or dyes, having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference in its entirety. Nanoparticle dispersions can also be produced by crystallization, precipitation, gas phase condensation, and chemical attrition (i.e., partial dissolution).

In order to minimize re-agglomeration of nanoparticles within the coating, a dispersion of resin-coated nanoparticles can be used. As used herein, a “dispersion of resin-coated nanoparticles” refers to a continuous phase in which is dispersed discrete “composite microparticles” that comprise a nanoparticle and a resin coating on the nanoparticle. Example dispersions of resin-coated nanoparticles and methods for making them are identified in U.S. Pat. No. 7,605,194 at col. 3, line 56 to col. 16, line 25, the cited portion of which being incorporated herein by reference.

Example special-effect compositions that may be used include pigments and/or compositions that produce one or more appearance effects, such as reflectance, pearlescence, metallic sheen, phosphorescence, fluorescence, photochromism, photosensitivity, thermochromism, goniochromism, and/or color change. Additional special-effect compositions can provide other perceptible properties, such as opacity or texture. In a non-limiting embodiment, special-effect compositions can produce a color shift, such that the color of the coating changes when the coating is viewed at different angles. Example color-effect compositions are identified in U.S. Pat. No. 6,894,086, incorporated herein by reference in its entirety. Additional color-effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 1 to 65 weight percent of the present compositions, such as from 3 to 30 weight percent, with weight percent based on the total weight of the compositions.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention have minimal migration out of the coating. Example photosensitive compositions and/or photochromic compositions, and methods for making them, are identified in United States Patent Application Publication No. 2006/0014099, and incorporated herein by reference in its entirety.

In general, the colorant can be present in any amount sufficient to impart the desired visual and/or color effect. The colorant may comprise from 1 to 65 wt. % of the present compositions, such as from 3 to 40 wt. % or 5 to 35 wt. %, with weight percent based on the total weight of the compositions.

An “abrasion-resistant particle” is one that, when used in a coating, will impart some level of abrasion resistance to the coating as compared with the same coating lacking the particles. Suitable abrasion-resistant particles include organic and/or inorganic particles. Examples of suitable organic particles include, but are not limited to, diamond particles, such as diamond dust particles, and particles formed from carbide materials; examples of carbide particles include, but are not limited to, titanium carbide, silicon carbide, and boron carbide. Examples of suitable inorganic particles include, but are not limited to, silica; alumina; alumina silicate; silica alumina; alkali aluminosilicate; borosilicate glass; nitrides including boron nitride and silicon nitride; oxides including titanium dioxide and zinc oxide; quartz; nepheline syenite; zircon such as in the form of zirconium oxide; buddeluyite; and eudialyte. Particles of any size can be used, as can mixtures of different particles and/or different sized particles. For example, the particles can be microparticles having an average particle size of 0.1 to 50, 0.1 to 20, 1 to 12, 1 to 10, or 3 to 6 microns, or any combination within any of these ranges. Nano-sized silica is particularly useful. Such nanoparticles may be introduced as a dispersion, such as a dispersion in a radiation-curable monomer or a dispersion in an organic solvent. The particles can be nanoparticles having an average particle size of less than 0.1 micron, such as 0.8 to 500, 10 to 100, or 100 to 500 nanometers, or any combination within these ranges. Nano-sized silica is particularly useful.

The compositions of the present invention may also further comprise a photoinitiator, such as one standardly used in the art to catalyze or accelerate cure if such cure is, at least in part, by exposure to ultraviolet radiation. Any suitable photoinitiator can be used, including any of the known photoinitiators such as benzophenone, benzoin, acetophenone, benzoin methyl ether, Michler's ketone, benzoin butyl ether, xanthone, thioxanthone, propiophenone, fluorenone, carbazole, diethoxyacetophenone, the 2-, 3- and 4-methylacetophenones and methoxy-acetophenones, the 2- and 3-chloroxanthones and chlorothioxanthones, 2-acetyl-4-methylphenyl acetate, 2,2′-dimethoxy-2-phenylacetophenone, benzaldehyde, fluorene, anthraquinone, triphenylamine, 3- and 4-allyl-acetophenone, p-diacetylbenzene, 3-chloro-2-nonylxanthone, 2-chlorobenzophenone, 4-methoxybenzophenone, 2,2′,4,4′-tetrachlorobenzophenone, 2-chloro-4′-methylbenzophenone, 4-chloro-4′-methylbenzophenone, 3-methylbenzophenone, 4-tert.butylbenzophenone, isobutyl ether-benzoic acetate, benzil benzilic acid, amino benzoate, methyl blue, 2,2-diethoxyacetophenone, 9,10-phenanthrenequinone, 2-methyl anthraquinone, 2-ethyl anthraquinone, 1-tert.butylanthraquinone, 1,4-naphthaquinone, isopropylthioxanthone, 2-isopropylthioxanthone, 2-methylthioxanthone, 2-decylthioxanthone, 2-dodecylthioxanthone, 2-methyl-1, [4-(methyl thio) phenyl]-2-morpholinopropanone-1, combinations thereof and the like.

It will be appreciated that the coatings described herein can be either one component (“1K”) or multi-component compositions, such as two component (“2K”). A 1K composition will be understood as referring to a composition wherein all of the coating components are maintained in the same container after manufacture, during storage, etc. A 1K coating can be applied to a substrate and cured by any conventional means, such as by heating, forced air, and the like. The present coatings can also be 2K coatings or multi-component coatings, which will be understood as coatings in which various components are maintained separately until just prior to application.

As noted above, certain of the coatings may be radiation curable. A “radiation-curable” coating will be understood as one that is cured by exposure to high energy or actinic radiation. A class of high-energy bombardment includes energetic electrons such as those derived from isotopes, such as strontium-90, or intense electron beams produced by particle accelerators. Electron beam curing is most useful in applications where very rapid and economical rates are desired. In some systems, curing periods of less than about one second may be used, which is a total radiation dose of less than about 0.25 megarads.

A class of actinic radiation useful according to the present invention is ultraviolet light; also suitable are other forms of actinic radiation that are normally found in radiation emitted from the sun or from artificial sources, such as Type RS Sunlamps, carbon arc lamps, xenon arc lamps, mercury vapor lamps, tungsten halide lamps, and the like. Ultraviolet radiation may be used most efficiently if the coating comprises a photocuring rate accelerator. Curing periods of from 1 second to 15 minutes are typical.

The present coatings can be applied to any substrate known in the art, for example automotive substrates, industrial substrates and packaging substrates. These substrates can be, for example, metallic or non-metallic, including polymeric, plastic, polycarbonate, polycarbonate/acrylobutadiene styrene (“PC/ABS”), poly(hydroxy alkanoate), polyamide, wood, veneer, wood composite, particle board, medium density fiberboard, cement, stone, and the like. In a particularly suitable embodiment of the present invention, the substrate itself is biobased. Alternatively, the substrate may be biodegradable. By “biodegradable” it is meant that the material may be chemically broken down by biological means, such as bacteria. Biodegradable substrates include, for example, paper, wood, and biodegradable plastics such as cellulose, poly(lactic acid), poly(3-hydroxybutyrate), and starch-based plastics. In addition, the substrate can be one that has been recycled. The substrate can also be one that has already been treated in some manner to impart color or other visual effect. For example, a wood substrate that has been stained may then be coated according to the present invention, as can a substrate that has already had one or more other coating layers applied to it.

As used herein, the term “polyamide substrate” refers to a substrate constructed from a polymer that includes repeating units of the formula:
Error! Objects cannot be created from editing field codes.,
   wherein R is hydrogen or an alkyl group. The polyamide may be any of a large class of polyamides based on aliphatic, cycloaliphatic, or aromatic groups in the chain. They may be formally represented by the products of condensation of a dibasic amine with a diacid and/or diacid chloride, by the product of self-condensation of an amino acid, such as omega-aminoundecanoic acid, or by the product of a ring-opening reaction of a cyclic lactam, such as caprolactam, lauryllactam, or pyrrolidone. They may contain one or more alkylene, arylene, or aralkylene repeating units. The polyamide may be crystalline or amorphous. In certain embodiments, the polyamide substrate comprises a crystalline polyamide of alkylene repeating units having from 4 to 12 carbon atoms, such as poly(caprolactam) (nylon 6), poly(lauryllactam) (nylon 12), poly(omega-aminoundecanoic acid) (nylon 11), poly(hexamethylene adipamide) (nylon 6.6), poly(hexamethylene sebacamide) (nylon 6.10), and/or an alkylene/arylene copolyamide, such as that made from meta-xylylene diamine and adipic acid (nylon MXD6). The term “nylon” includes all of these products as well as any other compound referred to in the art as nylon. Amorphous polyamides, such as those derived from isophoronediamine or trimethylcyclohexanediamine, may also be utilized. Blends of polyamides may also be utilized.

The coating composition of the present invention can be applied by any means standard in the art, such as electrocoating, spraying, electrostatic spraying, dipping, rolling, brushing, and the like.

The coatings can be applied to any dry film thickness, such as 0.1 to 4 mils, 0.3 to 2 mils, or 0.7 to 1.3 mils. The coatings of the present invention can be used alone (directly onto the substrate without any intervening coating or other material between the substrate surface and the coating composition of the present invention or any pretreatment of the substrate) or in combination with other coatings. For example, the coating can comprise a colorant or not and can be used as a primer, ecoat, basecoat, top coat, automotive repair coat, and the like. For substrates coated with multiple coatings, one or more of those coatings can be coatings as described herein.

As used herein, unless otherwise expressly specified, all numbers such as those expressing values, ranges, amounts, or percentages may be read as if prefaced by the word “about”, even if the term does not expressly appear. Also, any numerical range recited herein is intended to include all subranges subsumed therein. When ranges are given, any endpoints of those ranges and/or numbers within those ranges can be combined with the scope of the present invention. “Including”, “such as”, “for example” and like terms mean “including/such as/for example but not limited to”. Singular encompasses plural and vice versa. For example, although reference is made herein, including the claims, to “an” epoxy functional resin, “a” lactide, “a” compound comprising a radiation-curable moiety, “a” lactide reaction product, “a” crosslinker, and the like, one or more of any of these compounds can be used. Similarly, while the reaction products of the present invention are sometimes collectively referred to herein in the plural, i.e., reaction products, use of only one of any reaction product is within the scope of the present invention. “Including” means “including, but not limited to”. As used herein, the term “polymer” refers to oligomers and both homopolymers and copolymers, and the prefix “poly” refers to two or more.

### EXAMPLES

The following examples are intended to illustrate the invention and should not be construed as limiting the invention in any way.

### Examples 1-6

Lactide reaction products of the present invention were produced according to the following procedure. In a first charge, epoxy-functional backbone resin dispersed in a solvent was added to a flask fixed with a stirrer, nitrogen inlet, thermocouple, and condenser. The mixture was raised to a temperature of 80° C. A second charge containing the lactide, catalyst, and solvent was added, and the temperature was increased to 125° C. and maintained for 8 hours. See Table 1. The data presented in Table 1 includes the resulting percent solids and molecular weight (number average molecular weight, weight average molecular weight, and z-average molecular weight).

TABLE 1

| | | Example | Example | Example | Example | Example | Example |
|---|---|---|---|---|---|---|---|
| | | 1 | 2 | 3 | 4 | 5 | 6 |
| Charge 1 | EPIKOTE | 109.5 | 181.4 | 78.4 | | | |
| (parts by | 1009¹ | | | | | | |
| weight) | EPIKOTE | | | | 185.7 | 82.6 | 114.3 |
| | 1004² | | | | | | |
| | MiBK³ | 28.9 | 28.19 | 29.2 | 28.1 | 29.2 | 28.9 |
| Charge 2 | L-Lactide⁴ | 160.0 | 88.4 | 191.0 | 84.1 | 186.9 | 155.2 |
| (parts by | Stanous | 0.45 | 0.25 | 0.54 | 0.24 | 0.53 | 0.44 |
| weight) | octoate | | | | | | |
| | MiBK | 149.4 | 156.1 | 111.7 | 121.9 | 85.8 | 121.1 |
| Solids (% | | 60.5 | 58.5 | 64.1 | 70.8 | 71.7 | 67.6 |
| by weight) | | | | | | | |
| Molecular | Mn | 5600 | 3700 | 3400 | 3000 | 3400 | 3900 |
| weight | Mw | 51000 | 54000 | 35000 | 9400 | 21000 | 26000 |
| | Mz | 171306 | 244000 | 94000 | 18000 | 46000 | 73000 |
| Lactide:OH | | 3 | 1 | 5 | 1 | 5 | 3 |

¹Bisphenol A diglycidyl ether resin available from Momentive Specialty Chemicals B.V.
²Bisphenol A diglycidyl ether resin available from Momentive Specialty Chemicals B.V.
³Methyl isobutyl ketone
⁴(3S)-cis-3,6-dimethyl-1,4-dioxane-2,5-dione available from Sigma-Aldrich Co.

### Example 7

A coating system was prepared using the reaction product of Example 1. The reaction product of Example 1 was preblended with n-butyl acetate and then combined with the remainder of the compounds listed in Table 2 in a 2 oz jar and shaken for 30 minutes to combine. The resulting basecoat was reduced with solvent blend reducer (XPS90030 Durethane Solvent Reducer, available from PPG Industries, Inc.) on a 1:1 by weight basis and stirred until blended. The formulated and reduced coating composition was then applied to a bioplastic substrate as a basecoat. The coating composition was spray applied to a film build of approximately 0.8 mils using a Binks 95 gun set at 50 pounds of air and a full fan pattern. The basecoat was allowed to flash for about 10 minutes and then topcoated with approximately 1.0 mil of a 25% biocontent 2K isocyanate clear coat. The clear coat was allowed to flash for about 10 minutes and then baked for 30 minutes at 180° F. in an electric Despatch LFD series oven. Panels were tested for initial crosshatch adhesion as soon as cool. The panels were tested by pneumatic adhesion tensile test instrument (PATTI) adhesion (measuring the force required to pull the coating from the substrate) and crosshatch 2 days after cure and after exposure to condensing humidity for 6 days after cure. Table 2 lists the results of the crosshatch and PATTI testing at the indicated intervals.

TABLE 2

| | | Comparative |
|---|---|---|
| Material | Example 7 | Example 1 |
| Reaction product of Example 1 | 8.16 | |
| EPON 1009 solution | | 12.12 |
| n-butyl acetate | 5.11 | 1.15 |
| Black tint | 17.39 | 17.39 |
| Color blender | 19.35 | 19.35 |

Reduced 1:1 by weight with solvent blend reducer
Testing

| | | |
|---|---|---|
| Initial Crosshatch Adhesion¹ | 4B | 2B |
| 2 Day Crosshatch Adhesion | 4B | 0B |
| 6 Day Crosshatch Adhesion | 5B | 0B |
| Crosshatch Adhesion after 6 days humidity | 4B | N/A |
| exposure² | | |
| 2 Day PATTI Adhesion³ | 366 +/− 40 psi | N/A |
| PATTI Adhesion after 6 days humidity | 502 +/− 40 psi | N/A |
| exposure | | |

¹As per ASTM D3359, 1 mm crosshatch, two pulls using Nichiban tape. Visual rating of coating loss from crosshatch grid. Rating scale: 5B = 0% loss of adhesion, 4B = corner pick, 3B = 5-15% loss, 2B = 15-35% loss, 1B = 35-65% loss, 0B = >65% loss of adhesion.
²Humidity run as per ASTM D1735.
³Four pulls are averaged per sample.

### Comparative Example 1

A coating system was prepared as in Example 7, except that a solution of EPON 1009 (Momentive Specialty Chemicals Inc., Columbus, Ohio) (4 parts EPON 1009, 3 parts aromatic 100, and 3 parts ethanol) was used in place of the reaction product of Example 1. Adhesion testing thereof is also reported in Table 2.

In the 2 days post cure, the adhesion failure occurred within the substrate or at the substrate/basecoat interface. After 6 days humidity exposure, the adhesion failure occurred within the substrate indicating that the adhesive strength of the basecoat to the substrate was stronger than the integrity of the substrate itself. Unlike in Example 7, PATTI testing could not be conducted on the comparative example because the adhesion strength was too low to be measured by this method.

While the preferred embodiments of the present invention are described above, obvious modifications and alterations of the present invention may be made without departing from the spirit and scope of the present invention. The scope of the present invention is defined in the appended claims and equivalents thereto.

The invention claimed is:

1. A coating composition comprising a reaction product comprising:
(a) an epoxy-functional backbone resin having free hydroxyl groups; and
(b) a lactide.

2. The composition of claim 1, wherein the molar ratio of lactide segments in the reaction product to free hydroxyl groups present in the backbone resin prior to reaction is 1:1 to 5:1.

3. The composition of claim 2, wherein the molar ratio of lactide to hydroxyl group is 1:1 to 3:1.

4. The composition of claim 1, wherein the Mₙ of the epoxy-functional backbone resin is 1,000-10,000.

5. The composition of claim 1, wherein the epoxy-functional backbone resin comprises an aromatic group.

6. The composition of claim 5, wherein the epoxy-functional backbone resin comprises a bisphenol-A-based epoxy resin or residue thereof.

7. The composition of claim 1, wherein the reaction product comprises one or more pendent polylactide units.

8. The composition of claim 7, wherein each polylactide unit independently comprises 2-5 lactide segments.

9. The coating composition of claim 1, wherein the coating further comprises an additional film-forming resin.

10. The coating composition of claim 9, wherein the coating comprises a crosslinker reactive with the reaction product and/or the additional film-forming resin.

11. The coating composition of claim 10, wherein the crosslinker comprises a melamine resin, a polyisocyanate, and/or a blocked polyisocyanate.

12. The coating composition of claim 9, wherein the additional film-forming resin comprises a compound comprising a radiation curable moiety.

13. The coating composition of claim 12, wherein the radiation curable moiety comprises acrylic.

14. A substrate coated at least in part by the coating composition of claim 1.

15. The coated substrate of claim 14, wherein the substrate is non-metallic.

16. The coated substrate of claim 14, wherein the substrate is plastic.

17. The coated substrate of claim 15, wherein the substrate is bioplastic.

18. The coated substrate of claim 15, wherein the substrate is biodegradable plastic.

19. The coated substrate of claim 15, wherein the substrate comprises polycarbonate.

20. The coated substrate of claim 15, wherein the substrate comprises poly(hydroxyalkanoate).

21. The coated substrate of claim 15, wherein the coating composition is applied directly to the substrate with no intervening coating or pretreatment of the substrate.
